(19) United States
(12) Patent Application Publication
(10) Pub. No.: US 2019/0263711 A1
(43) Pub. Date: Aug. 29, 2019

(54) SUSPENDING DEVICE FOR OPTICAL FIBRE PREFORMS

(71) Applicant: Prysmian S.p.A., Milano (IT)

(72) Inventors: Stefano Grieco, Milano (IT); Valeria Caronna, Milano (IT); Franco Cocchini, Milano (IT); Antonio Schiaffo, Milano (IT)

(21) Appl. No.: 16/343,874

(22) PCT Filed: Oct. 24, 2016
(86) PCT No.: PCT/EP2016/075502

§ 371 Date: Apr. 22, 2019

(51) Int. Cl. C03B 37/014

(52) U.S. Cl. CPC C03B 37/01486

(57) ABSTRACT

An optical fibre preform suspending device for vertically holding an optical fibre preform by a preform handle comprising a handle enlarged-width portion is provided. The preform suspending device having a substantially cylindrical shape and comprising a housing portion having a receiving space with a front top opening and a front bottom opening and a supporting surface between the front top opening and the front bottom opening. The preform suspending device also comprises a supporting member placed on the supporting surface, for holding the handle enlarged-width portion. The supporting member is radially independent from the housing portion.

### FIELD OF THE INVENTION

The present invention relates to an optical fibre preform suspending device for holding an optical fibre preform in a vertical orientation by a preform handle.

### BACKGROUND OF THE INVENTION

Optical fibres for fibre-optics communications and optical networking are manufactured by first producing a large-diameter glass preform, which is then drawn down to an optical fibre of typical diameter of about 125 μm.

A common procedure to obtain a glass preform comprises a first process for producing a core rod of solid glass and a second process in which an overcladding is added to the core rod by a suitable process, e.g. by deposition of soot about the core rod or by jacketing the core rod in a glass tube (rod-in-tube technology).

Formation of a cladding region on the core rod by a flame hydrolysis deposition process, such as those commonly known as Outside Vapour Deposition (OVD), or Vapour Axial Deposition (VAD), is also often employed because it allows a relatively fast and economical process of producing a soot optical preform from a core rod. The partially porous soot preform is subsequently treated with a drying agent to remove water and it is then consolidated inside a furnace into a solid glass preform at temperatures higher than the glass transition temperature.

In case the core rod is produced starting from a soot precursor body, made for example by OVD or VAD process, dehydration and consolidation of the precursor body inside a furnace is needed to form a glass rod.

In processes commonly used for dehydration and consolidation, a porous or partially porous soot preform is vertically suspended to a supporting device configured to hold the preform and lowered into a vertically oriented furnace and then pulled up as a transparent silica glass preform above the furnace after vitrification.

The soot precursor body for the formation of a core rod is conventionally suspended from an integral handle, which forms part of the mandrel supporting structure during soot deposition.

After soot deposition of an overcladding layer on the core rod, the final preform is generally suspended by a quartz handle joined and often integral to the preform, typically fused to the core rod prior to the overcladding deposition.

Vertical hanging of the preform by the handle often makes use of an enlarged-width portion of the cylindrically shaped handle, such as a ball-shaped portion, which is housed in the supporting device.

U.S. Pat. No. 6,519,977 describes an optical fibre preform suspending and supporting apparatus comprising a chock integrally provided at the lower end of a shaft, having an insertion space open at one side and with a slit for insertion of a preform, made of a silica based glass to prevent invasion of impurities into the optical fiber preform.

A method of attaching and detaching a preform used to manufacture an optical fibre to and from a support body is described in U.S. Pat. No. 8,590,131, including inserting a connection pin through a penetration hole.

JP 2000-203862 discloses a hanging holder for a target rod in a heat furnace in the production of starting material for an optical fibre. The hanging holder comprises a disk-shaped base part connected to the bottom end of a lifting shaft; three hanging arms hung down from the circumference of the base part in equal divisions and supporters, which are integral to the bottom end of the hanging arms, support the target rod at its diameter-expanded shoulder formed at the upper end of the starting material by hooking the shoulder in equal divisions along the periphery.

US 2008/0000270 relates to a suspension-cum-holding device for an optical fibre preform. Particularly, it relates to an improved suspension-cum-holding device for suspending and holding an optical fibre preform in a sintering furnace. The suspension-cum-holding device comprises a cylindrical body provided with an opening towards the closed top end, which extends rearward to form a cylindrical hollow body which is provided with two openings in its lower surface, wherein the openings extend downwards respectively to form cylindrical bodies and the cylindrical bodies join and merge with each other at a point forming a body. The cylindrical body is provided with a ball support means at the interface of cylindrical bodies which is capable of supporting the handle ball provided on the preform handle of the optical fibre preform.

The Applicant has observed that a suspension system such that described in US 2008//0000270 may imply complicated movements for the loading of the preforms into the suspension-cum-holding device. The preform has to be inserted from below the device, pushed upward and then moved rearward to position the handle ball supporting means.

### SUMMARY OF THE INVENTION

A typical consolidation furnace for porous preforms has hot zones set at different temperatures, generally ranging from 800° C. to 1600° C. The handle and the suspension device, during a dehydration and/or consolidation process, are maintained in the hot zones for a relatively long time, e.g. up to 8 to 15 hours.

Use of large-size silica optical fibre preforms is desirable. Enlarging the size of an optical fibre preform bears advantages in terms of manufacturing costs because of the increased yield of produced fibre length resulting from a single preform, which can be expressed in kilometres of optical fibre per preform. An increase of the size naturally entails an increase of weight of the final preform provided with an overclad layer.

Applicant has noted that the weight of a preform, especially of a large-size preform of weight ranging from about 10 kg to about 30 kg or more, can apply a stress on the suspending device, when the preform is hung thereon.

Suspending devices are often made of quartz for its resistance at high temperatures, compatibility with the optical fibre material and minimisation of the risk of contamination. At high temperatures, such as those customary inside a consolidation furnace, stresses can produce a deformation of the quartz holder itself.

FIG. 1a schematically shows a partial vertical front view of a suspending device 1 made of quartz for hanging a preform (not shown) by a quartz handle 2 joined to the preform. The handle 2 is provided with an enlarged-width portion 3, which is in this case ball-shaped. The suspending device 1 comprises a substantially tubular body having a front insertion opening 4 through which the handle 2 is inserted in a central longitudinal hole for housing the handle. The ball-shaped portion 3 lays on a supporting surface 5 formed by the lower portion of the insertion opening 4, having smaller width than the upper portion of the insertion opening 4.

A relatively large weight preform may exert transversally directed forces, schematically indicated in FIG. 1b with arrows 6, from the ball-shaped portion 3 to the supporting surface 5 of the device. These forces, combined with the high temperature of the furnace, tend to cause the supporting surface to widen, causing an undesirable vertical displacement of the preform and, if the width of the supporting surface becomes too large for the handle ball-shaped portion, the ball-shaped portion may disengage from the supporting surface, finally causing the preform to fall down, as schematically indicated by arrow 7.

The Applicant has realised that an independent supporting member interposed between the supporting surface of the preform suspending device and the handle enlarged-width portion can hinder the deformation under load of the suspending device and therefore significantly reduce or eliminate the occurrence of downfall of the preform. An increasing of the lifetime of the suspending device is also obtained.

Consistently with the present invention, an optical fibre preform suspending device for vertically holding an optical fibre preform by a preform handle comprising a handle enlarged-width portion is provided, the preform suspending device having a substantially cylindrical shape and comprising:
a housing portion having:
   a receiving space with a front top opening and a front bottom opening, and
   a supporting surface between the front top opening and the front bottom opening,
a supporting member placed on the supporting surface, for holding the handle enlarged-width portion,
   wherein the supporting member is radially independent from the housing portion.

Throughout the present description and in the subsequent claims, the expression “radially independent” is used to indicate that a deformation of the supporting member is independent of a deformation of the housing portion in the direction of the radius of the suspending device.

Preferably, the supporting member covers at least 80% of the supporting surface width.

Preferably, the housing portion is made of quartz.

Preferably, the whole suspending device is made of quartz.

Preferably, the suspending device comprises an upper connecting portion to the housing portion configured to operatively connect to a vertical driving device.

Preferably, the supporting member is a U-shaped element.

Preferably, the supporting member has a thickness from 2 mm to 15 mm, preferably from 4 mm to 12 mm.

Preferably, the supporting member is made of a material having a melting point of at least 2000° C.

More preferably, the supporting member is made of a ceramic material

More preferably, the supporting member is made of a non-oxygen-combustible material; more preferably, the supporting member is made of graphite or graphite based material, alumina or alumina based material.

The provision of a supporting member made of a material with a melting point significantly higher than that of quartz (e.g. about 1700° C. for fused silica) avoids the occurrence of a partial soldering of the handle, typically made of quartz, to the supporting surface of the quartz holder. This may greatly simplify the removal of the glass preform after consolidation.

### BRIEF DESCRIPTION OF THE DRAWINGS

The present invention will now be described in more detail hereinafter with reference to the accompanying drawings, in which some embodiments of the invention are shown. Drawings illustrating the embodiments are not-to-scale schematic representations.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein.

FIG. 1a and FIG. 1b are vertical front views of part of a suspending device for hanging a preform (not shown) by a handle, in original condition and in the presence of a deformation, respectively.

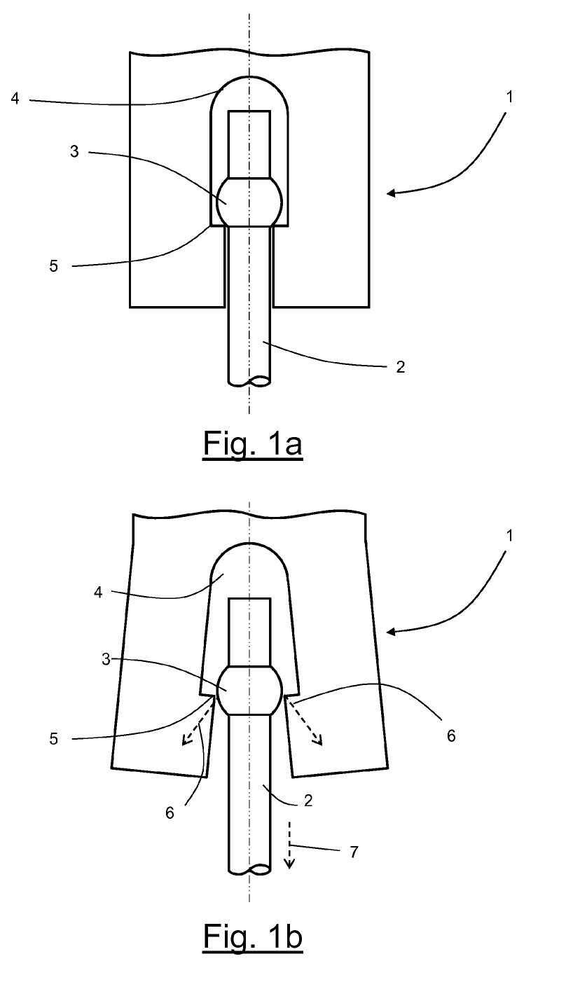

FIG. 2 is a schematic vertical front view of a suspending device according to the invention, showing also the positional relationship of a handle joined to a partially porous preform to the supporting portion of the device.

FIG. 3 is a partial section perspective view of suspending device of FIG. 2 (optical fibre preform with handle not shown).

FIG. 4 is cross section of the suspending device of FIG. 2, along the plane IV-IV.

FIG. 5 is an enlarged vertical front view of part of a suspending device for hanging a preform (not shown) by a handle, according to the invention, in rest condition.

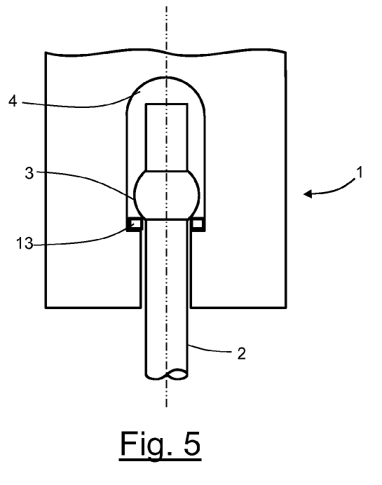

### DETAILED DESCRIPTION

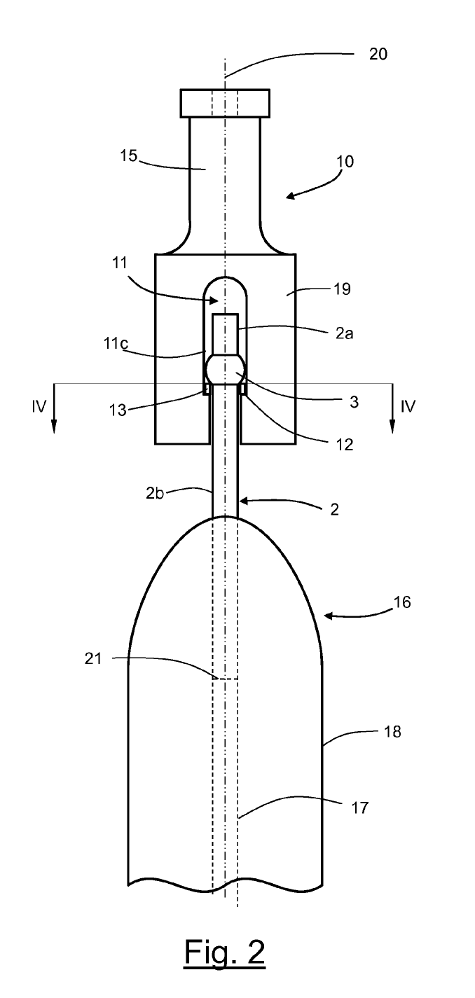

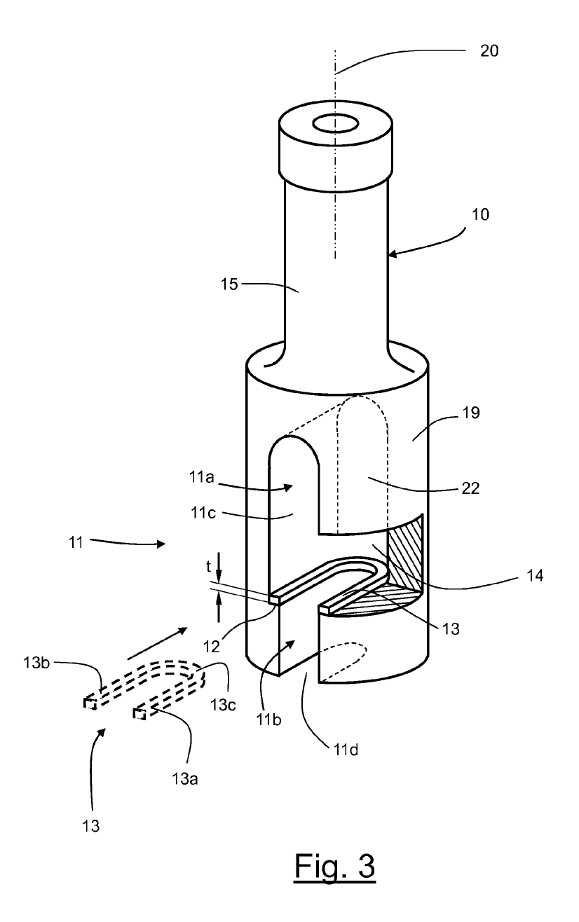

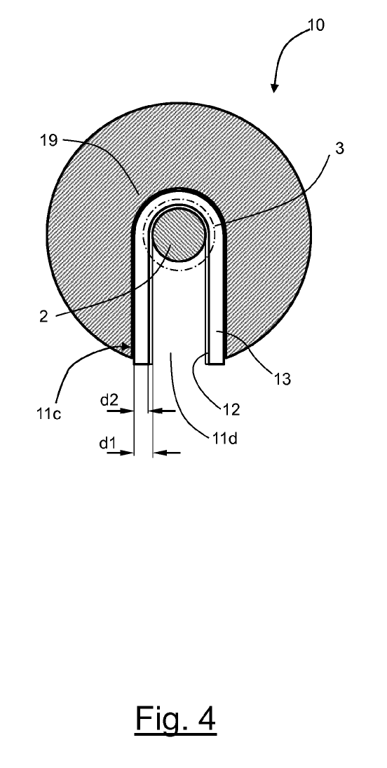

FIG. 2 is a schematic vertical front view of a suspending device for holding a preform by a handle. The figure shows also the positional relationship of a handle joined to a partially porous preform and the supporting portion of the device. FIGS. 3 and 4 are, respectively, a partial section perspective view and a cross-section view of the suspending device of FIG. 2, in which the handle and the preform are not shown.

An optical fibre preform 16 is suspended, at its upper end, in a vertical orientation to a suspending and holding device 10 by a handle 2, which is joined to the preform. In the embodiment shown in FIG. 2, the preform 16 is partially porous and comprises a glass core rod 17 surrounded by a silica soot overcladding layer 18 deposited on the core rod.

The handle 2 is attached at one end of the core rod 17, e.g. by fusing the handle to the rod 17 at the position schematically indicated with referral number 21. Preferably, the handle is made of fused quartz, with a composition similar to the one of the silica glass of the core rod. Within the context of the present disclosure, with handle it is indicated an element by which the preform is manipulated and/or supported. It is possible, for example, for the handle to be integral with the core rod or separately attached to the core rod.

The handle 2 is generally cylindrical in shape and comprises an enlarged-width longitudinal portion 3, which is shaped as a spherical ball of diameter larger than that of remaining upper and lower portions 2a and 2b of the handle. It is to be understood that the enlarged-width portion may have a different shape from a spherical ball and/or it may be located at the upper end of the handle, instead of at an intermediate portion of the same.

Commonly employed methods of manufacturing the glass core rod are for example an inside tube deposition process, such as plasma chemical vapour deposition (PCVD), or an outside deposition process, such as outside vapour deposition (OVD) or vapour axial deposition (VAD).

The suspending device 10 comprises a housing portion 19 having a receiving space 11, configured to house the preform handle 2.

The receiving space 11 comprises an upper cavity 11c, forming a front top opening 11a on the front surface of the suspending device 10, and a lower cavity 11d, forming a front bottom opening 11b on the front surface of the suspending device. The lower cavity 11d is open on the bottom face of the suspending device 10.

The lower cavity 11d has a smaller width than the upper cavity 11c.

The lower cavity 11d and the upper cavity 11c are sized for the insertion, respectively, of the preform handle 2 and of the enlarged-width portion 3 of the preform handle 2.

Preferably, at least the housing portion 19 of the suspending device 10 is made of quartz, more preferably, the whole suspending device is made of quartz.

Between the upper cavity 11c and the lower cavity 11d a supporting surface 12 is defined. Preferably, the supporting surface 12 is horizontal, and perpendicular to the vertical lay of suspension of the preform, indicated by the longitudinal axis 20, which corresponds to the main longitudinal extension of the suspending device 10.

Preferably, there is a clearance in the longitudinal direction between the handle and the sidewalls of the lower cavity.

Preferably, the upper cavity 11c and the lower cavity 11d have a U-shaped cross-section.

The supporting surface 12 defines a bottom surface of the cavity 11c for the engagement of the enlarged-width portion of the handle.

A supporting member 13 is placed on the supporting surface 12 for supporting the handle enlarged-width portion 3, wherein the supporting member 13 is configured to lay over the supporting surface 12 and to leave sufficient room in the receiving space clear for the insertion of the handle. In this way, when the preform handle is inserted in the receiving space, the enlarged-width portion 3 of the handle lays on the supporting member 13.

Preferably, the supporting member 13 substantially extends substantially over the whole supporting surface 12. Covering substantially the whole supporting surface 12 is preferred in order to reduce the precision required for the insertion of the handle in the receiving space of the suspending device.

With “substantial covering of the whole (supporting) surface” it is meant that the horizontal width of the supporting member 13 is equal to or smaller by less than about 20% than the width of the supporting surface 12, to allow for normal manufacturing tolerances.

The supporting surface 12 is preferably a continuous surface between two ends at the front opening of the suspending device.

The supporting member 13 is preferably removably disposed on the supporting surface 12, as indicated in FIG. 3. The supporting member 13 can be inserted in the receiving cavity 11 and laid down on the supporting surface 12. This enables an easy substitution of the supporting member 13 in case of its accidental damage, wear or rupture during handling of the piece.

Preferably, the supporting surface 12 is U-shaped and the supporting member 13 is U-shaped and extends over at least a portion of the supporting surface 12.

Preferably, the U-shaped supporting member 13 extends over at least a portion of the width of the supporting surface 12, which is not less than 80% of the surface width of the supporting surface 12.

Preferably, the supporting member 13 comprises two parallel arms 13a, 13b extending from a connection curved portion 13c. The distance between the arms 13a, 13b is selected to allow an easy insertion of the preform handle 2.

For example, the supporting surface 12 has width d1 of 5 mm and the U-shaped supporting member 13 has width d2 of 4 mm, as shown in FIG. 4.

It is to be understood that numerical examples are purely indicative since dimensions of the supporting surface 12 and thus of the supporting member 13 may depend on the size of the enlarged-width portion of the handle.

Preferably, the supporting member 13 is made of a material having a melting point of at least 2000° C., preferably a ceramic material.

Given that temperatures used for dehydration and consolidation of porous soot preforms typically range from 1300° C. to 1650° C., a relatively high melting point prevents thermal deformation of the supporting member 13 during dehydration and sintering of the preform.

Preferably, the melting point of the material of the supporting member 13 is of at least about 1750° C.

Preferably, the supporting member 13 is made of a non-oxygen-combustible material, such as graphite or a graphite-based material.

Alternatively, the supporting member 13 is made of alumina or an alumina based material.

Preferably, the supporting member 13 has a thickness t of from 2 mm to 15 mm, preferably of from 4 mm to 12 mm.

The suspending device 10 further comprises an upper connecting portion 15 connected with or integral to the housing portion 19 and arranged above the same. The upper connecting portion 15 is configured to be operatively connected to a vertical driving device (not shown in the figures), for vertically moving the suspended preform. Preferably, the upper connecting portion is integral to the housing portion so as to form a whole body, the body being preferably made of quartz.

The vertical driving device for lowering the preform into the furnace can be of conventional type. Typically, the furnace body of a furnace for dehydration and consolidation of optical fibre preforms is elongated, for example of a generally cylindrical shape and a conventional vertical driving device imparts to the suspending device a translational movement (up and down in the downfeed direction 20) along the furnace body, for example by means of a guide and a translational transfer mechanism. A rotation around the downfeed direction may be also imparted to the preform from a motor mounted on the vertical driving device.

1. An optical fibre preform suspending device for vertically holding an optical fibre preform by a preform handle comprising a handle enlarged-width portion, the preform suspending device having a substantially cylindrical shape and comprising:
a housing portion having:
a receiving space with a front top opening and a front bottom opening, and
a supporting surface between the front top opening and the front bottom opening,
a supporting member placed on the supporting surface, for holding the handle enlarged-width portion,
wherein the supporting member is radially independent from the housing portion.

2. The suspending device of claim 1, wherein the housing portion is made of quartz.

3. (canceled)

4. The suspending device of claim 1, wherein the supporting member is made of a ceramic material.

5. The suspending device of claim 4, wherein the supporting member is made of a non-oxygen-combustible material.

6. The suspending device of claim 4, wherein the supporting member is made of graphite.

7. The suspending device of claim 4, wherein the supporting member is made of alumina.

8. The suspending device of claim 1, wherein the supporting member covers at least 80% of the supporting surface width.

9. The suspending device of claim 1, wherein the supporting member is U-shaped.
